(19) United States
(12) Patent Application Publication
(10) Pub. No.: US 2022/0151858 A1
(43) Pub. Date: May 19, 2022

(54) Exoskeleton Powered Using an Ultracapacitor

(71) Applicant: KYOCERA AVX Components Corporation, Fountain Inn, SC (US)

(72) Inventor: Laurent Desclos, San Diego, CA (US)

(21) Appl. No.: 17/527,259

(22) Filed: Nov. 16, 2021

Related U.S. Application Data
(60) Provisional application No. 63/114,207, filed on Nov. 16, 2020.

(51) Int. Cl. A61H 3/00

(52) U.S. Cl. CPC A61H 3/008; A61H 2003/007; A61H 2201/165

(57) ABSTRACT

A powered exoskeleton is disclosed. The powered exoskeleton comprises: a power system including at least one ultracapacitor, wherein the ultracapacitor includes a housing and an electrode assembly and electrolyte within the housing; and first exoskeleton member and a second exoskeleton member connected to at least one actuator at an exoskeleton joint; wherein the at least one actuator is electrically coupled to and powered by the power system to actuate the exoskeleton joint.

### CROSS-REFERENCE TO RELATED APPLICATION

The present application claims filing benefit of U.S. Provisional Patent Application Ser. No. 63/114,207 having a filing date of Nov. 16, 2020, and which is incorporated herein by reference in its entirety.

### BACKGROUND OF THE INVENTION

Exoskeletons are generally passive or powered structures worn and controlled by an individual, typically to allow them to manipulate items with less physical exertion than would be necessary without the exoskeleton. In particular, a powered exoskeleton applies forces to one or more links of an exoskeleton structure to reduce the amount of force that an individual would otherwise have to apply. Furthermore, exoskeletons may generally be utilized in conjunction with any part of the body, including the upper body and/or lower body. For instance, when utilized with the upper body, an exoskeleton may be used to assist a user in moving relatively heavy items from one location to another location or in repeated movements. While conventional exoskeletons are powered by batteries, there are currently few power sources of sufficient energy density for powering these exoskeletons. Accordingly, there is a need to provide a powered exoskeleton with an improved power system.

### SUMMARY OF THE INVENTION

In accordance with one embodiment of the present invention, a powered exoskeleton is disclosed. The powered exoskeleton comprises a power system including at least one ultracapacitor wherein the at least one ultracapacitor includes a housing and an electrode assembly and electrolyte within the housing; and a first exoskeleton member and a second exoskeleton member connected to at least one actuator at an exoskeleton joint; wherein the at least one actuator is electrically coupled to and powered by the power system to actuate the exoskeleton joint.

Other features and aspects of the present invention are set forth in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figure in which:

FIG. 1 illustrates one embodiment of a powered exoskeleton according to the present invention;

FIG. 2 illustrates another embodiment of a powered exoskeleton according to the present invention;

FIGS. 3 and 4 illustrate embodiments of the housing of the ultracapacitor of the present invention;

FIG. 5 illustrates one embodiment of a current collector that may be employed in the ultracapacitor of the present invention;

FIG. 6 illustrates one embodiment of a current collector/carbonaceous coating configuration that may be employed in the ultracapacitor of the present invention; and

FIG. 7 illustrates one embodiment for forming an electrode assembly that can be used in the ultracapacitor of the present invention.

Repeat use of reference characters in the present specification and drawing is intended to represent same or analogous features or elements of the invention.

### Detailed Description of Representative Embodiments

It is to be understood by one of ordinary skill in the art that the present discussion is a description of exemplary embodiments only, and is not intended as limiting the broader aspects of the present invention, which broader aspects are embodied in the exemplary construction.

Generally speaking, the present invention is directed a powered exoskeleton including a power system comprising at least one ultracapacitor. For instance, the powered exoskeleton may include at least one actuator electrically coupled to the power system and powered by the power system to actuate at least one component of the exoskeleton. Providing a powered exoskeleton with such a power system may allow for more natural and energetic movements. For instance, ultracapacitors generally are capable of charging and discharging more rapidly than other power sources, such as batteries. Accordingly, a power system including at least one ultracapacitor may be able to provide a burst of power as necessary for specific movements thereby providing a more natural movement akin to the natural movements of the human body.

In general, the powered exoskeleton is a wearable exoskeleton. In this regard, the exoskeleton is able to decrease the user's energy consumption while wearing and/or enable various physical activities of the user. In some examples, this could include providing forces to the body of the user to augment forces applied by the musculature of the user's body.

The exoskeleton may be utilized in conjunction with various parts of the human body. For instance, in one embodiment, the exoskeleton may be for use with the lower body of a user. In another embodiment, the exoskeleton may be for use with the upper body of a user. In a further embodiment, exoskeleton may be for use with the lower body and the upper body of a user. Examples of exoskeletons may be used individually or in combination include a back exoskeleton, a torso exoskeleton, a shoulder exoskeleton, an elbow exoskeleton, a hand exoskeleton, a hip exoskeleton, a knee exoskeleton, a foot exoskeleton, etc. In one embodiment, the exoskeleton may be a full body exoskeleton as generally known in the art.

In this regard, as indicated above, the actuator as disclosed herein can actuate at least one component of the exoskeleton. The at least one component is not necessarily by the present invention. For instance, the at least one component may be a member of the exoskeleton operatively attachable to a part of a body of a user. For instance, the part of the body may be a limb. In one embodiment, the limb may be an upper limb. For instance, in one embodiment, the limb may be an arm. In another embodiment, the limb may be a hand. Alternatively or in addition, the limb may be a lower limb. For instance, in one embodiment, the limb may be a leg. In another embodiment, the limb may be a foot. In a further embodiment, the limb may be a thigh. However, it should be understood that the parts of the body are not limited to limbs. Regardless, parts of the body may also include, but are not limited to, the back, the hip, the knee, the elbow, the shoulder, the ankle, etc.

Regardless of the part of the body to which it is attached, the exoskeleton of the present invention includes at least one actuator. In general, the actuator is configured to move a user and cause movement of the exoskeleton. For instance, the actuators may provide assistance to the user during flexure or extension movements. Accordingly, the exoskeleton may have an exoskeleton joint corresponding to the location of a joint of the human body. The actuator can exert a force on a joint resulting in movement of the exoskeleton as well as a user coupled thereto. Accordingly, the actuated joints may augment the strength of an exoskeleton user.

In general, the actuator is a type of motor for moving or controlling a mechanism or system. In this regard, the actuator as disclosed herein is capable of moving or controlling the exoskeleton and accordingly a joint of a user. The type of actuator utilized according to the present invention is not limited so long as it assists a user with movements about a joint. For instance, the actuator can generate a torque to drive the joint to produce movement, such as a rotatory movement. Accordingly, the actuator may be electric, pneumatic, or hydraulic. The actuators may include, without limitation, AC (alternating current) motors, brush-type DC (direct current) motors, brushless DC motors, electronically commutated motors (ECMs), stepping motors, hydraulic actuators, and pneumatic actuators and combinations thereof.

As indicated above, in one embodiment, the exoskeleton includes at least one actuator. In one embodiment, the exoskeleton may include a plurality of actuators to drive a combination of joints. In some embodiments, the joints comprising the exoskeleton may additionally and/or alternatively comprise any mechanism known in the art to enable the parts of the exoskeleton to have the degrees of freedom present in the human body. In one embodiment, the mechanism enabling the part of the exoskeleton to have a determined degree of freedom may be adjustable.

In one embodiment, the exoskeleton may include a first exoskeleton member and a second exoskeleton member. The actuator may be configured to create a torque between the first exoskeleton member and the second exoskeleton member. In this regard, the actuator may cause rotation or movement of an exoskeleton joint and accordingly the joint of the human body. Such exoskeleton joint may be the location at which at the first exoskeleton member and the second exoskeleton member are joined or mechanically connected in order to allow for rotation or movement about such joint. In one embodiment, the exoskeleton may include multiple exoskeleton members, such as more than 2 exoskeleton members. Furthermore, an exoskeleton joint may connect at least two exoskeleton members, such as the first exoskeleton member and the second exoskeleton member. The exoskeleton joint may be adapted to permit flexion and extension between the respect exoskeleton members.

In one embodiment, the exoskeleton may include a first exoskeleton member, a second exoskeleton member, and a third exoskeleton member. The first and second exoskeleton members may be connected to at least one actuator at a first exoskeleton joint. The second and third exoskeleton members may be connected to a second actuator at a second exoskeleton joint. As disclosed herein, each actuator may be electrically coupled to and powered by a respective power system. Similarly, each actuator may be electrically coupled to a respective control unit as disclosed herein.

To power the exoskeleton, a power system as disclosed herein can be utilized. In particular, the power system can be utilized to power the actuator and accordingly the exoskeleton. In this regard, the power system may be electrically coupled to the actuator. For instance, in one embodiment, it may be directly electrically coupled in one embodiment. In another embodiment, it may be indirectly electrically coupled.

The power system may be utilized to power multiple actuators on the exoskeleton in one embodiment. In one embodiment, multiple power systems may be utilized to power one actuator. Alternatively or in addition, multiple power systems may be utilized to power multiple actuators. For instance, each actuator may be powered by a respective power system. Furthermore, when multiple power systems are utilized, they may be located proximal to the actuators that are being provided power by that respective power system. However, if the power system is not proximally located to the actuator to which power is being provided, power may be transferred using a transmission wire or cable as known in the art. In one embodiment, when multiple power systems are utilized, if power is depleted within one power system or falls below a certain threshold, power may then be provided for a particular actuator using another power system on the exoskeleton or a reserve power system. In this regard, the reserve power system may be electrically connected to the control unit which can provide a signal indicating a need for power to be supplied by the reserve power system.

In some embodiments, the actuators may be operatively coupled to a gearbox to achieve the desired movement. The actuators and the gearbox may be operatively coupled to the exoskeleton, in particular the exoskeleton members are disclosed herein. The gearbox may include a plurality of gears to transmit rotation axis of the actuator. For instance, the actuator may be powered and allow for rotation of the gears which in turn results in actuation of the exoskeleton joint to achieve the desired movement. In on embodiment, the exoskeleton may only include a single gearbox. In another embodiment, the exoskeleton may include a plurality of gearboxes. For each, in one embodiment, each actuator on the exoskeleton may include a respective gearbox. Alternatively, a plurality of actuators may be associated with one gearbox.

The exoskeleton may also include a control unit. The control unit may be electrically connected to the power system. The control unit may also be electrically connected to the actuators. For instance, the control unit may control and/or determine how much power to supply to the actuator. The control unit may also be used to determine when to supply power. The control unit may be used to determine how often to supply power and/or a patter of providing power. The control unit may, in one embodiment, may be utilized for any combination of the aforementioned functions to support and/or assist a user of the exoskeleton. In on embodiment, the exoskeleton may only include a single control unit. In another embodiment, the exoskeleton may include a plurality of control units. For each, in one embodiment, each actuator on the exoskeleton may include a respective control unit. Alternatively, a plurality of actuators may be associated with one control unit.

The control unit may prescribe and control trajectories in the joints of the exoskeleton, resulting the in the movement of the exoskeleton. The trajectories can be prescribed as position-based, force-based, or a combination of both methodologies, such as those seen in impedance controllers. Position-based control systems can be modified directly through modification of the prescribed positions. Force-based control systems can also be modified directly through modification of the prescribed force profiles. Complicated exoskeleton movements, such as walking in an ambulatory medical exoskeleton, may be commanded by an exoskeleton control system through the use of a series of exoskeleton trajectories, with increasingly complicated exoskeleton movements requiring an increasingly complicated series of exoskeleton trajectories. These series of trajectories can be cyclic, such as the exoskeleton taking a series of steps with each leg, or they can be discrete, such as an exoskeleton rising from a seated position into a standing position.

In some embodiments, the exoskeleton may be equipped with one or more sensors as known in the art. For instance, the sensors may report information on the state of the exoskeleton to the control unit. In one embodiment, the sensor may relay information directly to the actuators in the exoskeleton. The exoskeleton sensors may also draw their power from the power system as disclosed herein.

In addition, the exoskeleton may also include one or more attachment members to attach the exoskeleton to a user. For instance, the exoskeleton may comprise an outer framework. In this regard, when utilized with a specific part of the body, the attachment member may allow for the exoskeleton, in particular the outer framework, to be operatively attached to the user. The attachment member is not necessarily limited by the present invention so long as the exoskeleton is attached to a user. The attachment member may include, but is not limited to, one or more vests, belts, straps, casts, harnesses, links, etc. as well as combinations thereof.

In some embodiments, the exoskeleton may also include a control pad for human-machine interfacing. Specifically, the control pad may include a power unit meter which may indicate the amount of power that is remaining in the exoskeleton.

In one embodiment, the power system may be externally mounted to the exoskeleton. For instance, the power system may be interchangeable with a replacement power system while the exoskeleton remains on a user. Furthermore, by placing the power system externally, it may be capable of being rechargeable. In particular, it may be capable of wireless charging. In this regard, the power system may be recharged while mounted on the exoskeleton. Alternatively, the power unit may be removed and recharged while detached from the exoskeleton.

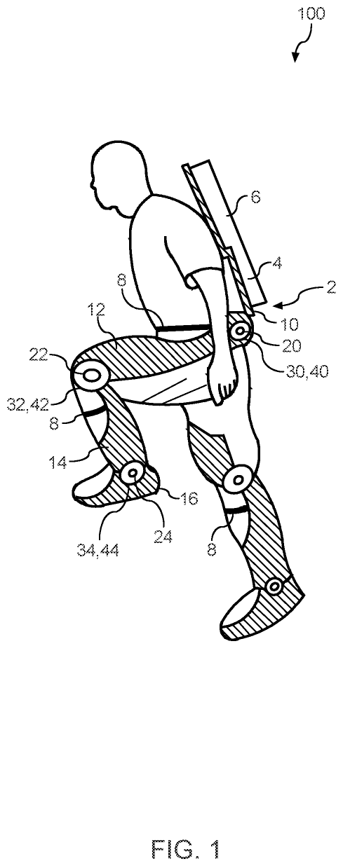

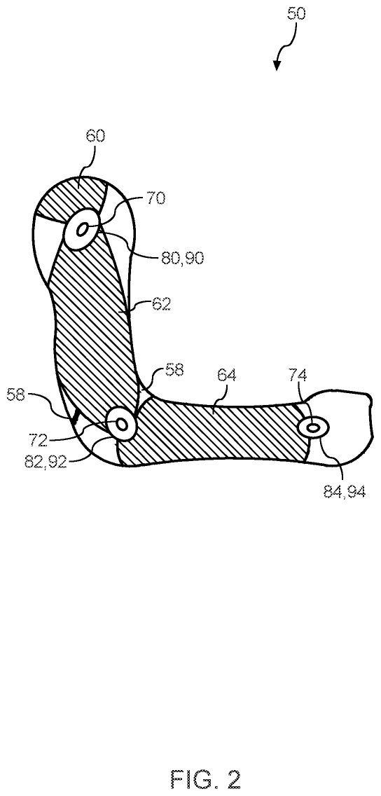

Examples of the powered exoskeleton as disclosed herein are further illustrated in FIGS. 1-2 and described below. In FIG. 1, a user 100 is wearing a powered exoskeleton 2. The powered exoskeleton includes a first member 10, a second member 12, a third member 14, and a fourth member 16. The powered exoskeleton includes a first exoskeleton joint 20, a second exoskeleton joint 22, and a third exoskeleton joint 24. The powered exoskeleton also includes a power system 4 and a control unit 6. Within the exoskeleton joints, the powered exoskeleton may also include an actuator 30, 32, 34. These joints may also include a gearbox 40, 42, 44. The exoskeleton may also include one or more attachment members 8. As illustrated, the exoskeleton provides assistance about the hip joint, knee joint, and/or ankle joint. However, as indicated above, it should be understood that the exoskeleton may provide assistance about other joints, such as the wrist, elbow, shoulder, etc.

For instance, FIG. 2 illustrates a powered exoskeleton 50 including a first member 60, a second member 62, and a third member 64. The powered exoskeleton includes a first exoskeleton joint 70, a second exoskeleton joint 72, and a third exoskeleton joint 74. The powered exoskeleton may also include an actuator 80, 82, 84. These joints may also include a gearbox 90, 92, 94. The exoskeleton may also include one or more attachment members 58.

As indicated herein, the power system may only include one or more ultracapacitors. In this regard, the power system may not utilize any other sources of power, such as a battery. However, in another embodiment, the power system may include a combination of one or more ultracapacitors and one or more batteries. Further, the power system may be augmented by an internal combustion engine coupled to a generator, a pneumatic cylinder, or a hydraulic pump.

The number of ultracapacitors utilized in the power system is not limited by the present invention. When utilizing multiple ultracapacitors, they may be presented as a module. In this regard, in one embodiment, the ultracapacitors may be electrically connected in series. In another embodiment, the ultracapacitors may be connected in parallel. Regardless, the ultracapacitors utilized according to the present invention are not necessarily limited. One embodiment of an ultracapacitor that may be utilized according to the present invention is further described below.

Ultracapacitor

The ultracapacitor 72 includes a housing within which an electrode assembly and electrolyte are retained and sealed. The electrode assembly contains a first lead 74 that is electrically connected to a first electrode (not shown) and a second lead 76 that is electrically connected to a second electrode (not shown). The leads 74 and 76 extend outwardly from the electrode assembly and ultracapacitor. The leads 74 and 76 may extend from opposing ends of the electrode assembly and ultracapacitor 72. However, it should be understood that the leads 74 and 76 may extend from the same end of the electrode assembly and ultracapacitor 72.

Electrode Assembly

In general, the ultracapacitor contains an electrode assembly including a first electrode, a second electrode, and a separator. For instance, the first electrode typically includes a first electrode containing a first carbonaceous coating (e.g., activated carbon particles) electrically coupled to a first current collector, and a second electrode typically includes a second carbonaceous coating (e.g., activated carbon particles) electrically coupled to a second current collector. A separator may also be positioned between the first electrode and the second electrode. In addition, the ultracapacitor contains first and second leads that are electrically connected to first and second electrodes, respectively.

Various embodiments of such an assembly are described in more detail below.

Electrodes

As indicated above, the ultracapacitor includes an electrode assembly including a first electrode and a second electrode. The electrodes employed within the assembly generally contain a current collector. The current collectors may be formed from the same or different materials. For instance, in one embodiment, the current collectors of each electrode are formed from the same material. Regardless, each collector is typically formed from a substrate that includes a conductive metal, such as aluminum, stainless steel, nickel, silver, palladium, etc., as well as alloys thereof. Aluminum and aluminum alloys are particularly suitable for use in the present invention.

The current collector substrate may be in the form of a foil, sheet, plate, mesh, etc. The substrate may also have a relatively small thickness, such as about 200 micrometers or less, such as about 150 micrometers or less, such as about 100 micrometers or less, such as about 80 micrometers or less, such as about 50 micrometers or less, such as about 40 micrometers or less, such as about 30 micrometers or less. The substrate may have a thickness of about 1 micrometer or more, such as about 5 micrometers or more, such as about 10 micrometers or more, such as about 20 micrometers or more.

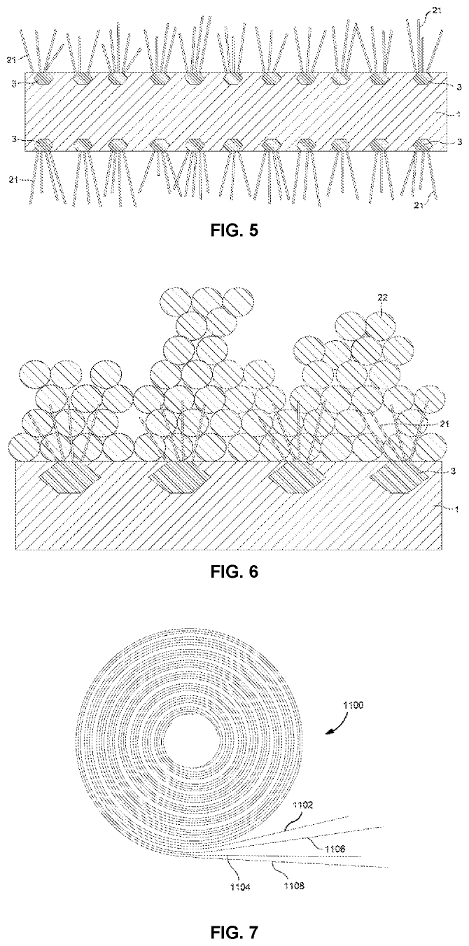

Although by no means required, the surface of the substrate may be treated. For example, in one embodiment, the surface may be roughened, such as by washing, etching, blasting, etc. In certain embodiments, the current collector may contain a plurality of fiber-like whiskers that project outwardly from the substrate. Without intending to be limited by theory, it is believed that these whiskers can effectively increase the surface area of the current collector and also improve the adhesion of the current collector to the corresponding electrode. This can allow for the use of a relatively low binder content in the first electrode and/or second electrode, which can improve charge transfer and reduce interfacial resistance and consequently result in very low ESR values. The whiskers are typically formed from a material that contains carbon and/or a reaction product of carbon and the conductive metal. In one embodiment, for example, the material may contain a carbide of the conductive metal, such as aluminum carbide (Al₄C₃). Referring to FIG. 5, for instance, one embodiment of a current collector is shown that contains a plurality of whiskers 21 projecting outwardly from a substrate 1. If desired, the whiskers 21 may optionally project from a seed portion 3 that is embedded within the substrate 1. Similar to the whiskers 21, the seed portion 3 may also be formed from a material that contains carbon and/or a reaction product of carbon and the conductive metal, such as a carbide of the conductive metal (e.g., aluminum carbide). Further, FIG. 6 illustrates an electrode including the aforementioned current collector having a plurality of whiskers 21 projecting outwardly from a substrate 1 in combination with a carbonaceous coating 22 as described herein.

The manner in which such whiskers are formed on the substrate may vary as desired. In one embodiment, for instance, the conductive metal of the substrate is reacted with a hydrocarbon compound. Examples of such hydrocarbon compounds may include, for instance, paraffin hydrocarbon compounds, such as methane, ethane, propane, n-butane, isobutane, pentane, etc.; olefin hydrocarbon compounds, such as ethylene, propylene, butene, butadiene, etc.; acetylene hydrocarbon compounds, such as acetylene; as well as derivatives or combinations of any of the foregoing. It is generally desired that the hydrocarbon compounds are in a gaseous form during the reaction. Thus, it may be desired to employ hydrocarbon compounds, such as methane, ethane, and propane, which are in a gaseous form when heated. Although not necessarily required, the hydrocarbon compounds are typically employed in a range of from about 0.1 parts to about 50 parts by weight, and in some embodiments, from about 0.5 parts by weight to about 30 parts by weight, based on 100 parts by weight of the substrate. To initiate the reaction with the hydrocarbon and conductive metal, the substrate is generally heated in an atmosphere that is at a temperature of about 300° C. or more, in some embodiments about 400° C. or more, and in some embodiments, from about 500° C. to about 650° C. The time of heating depends on the exact temperature selected, but typically ranges from about 1 hour to about 100 hours. The atmosphere typically contains a relatively low amount of oxygen to minimize the formation of a dielectric film on the surface of the substrate. For example, the oxygen content of the atmosphere may be about 1% by volume or less.

The electrodes used in the ultracapacitor also contain carbonaceous materials that are coated onto opposing sides of the current collectors. While they may be formed from the same or different types of materials and may contain one or multiple layers, each of the carbonaceous coatings generally contains at least one layer that includes activated particles. In certain embodiments, for instance, the activated carbon layer may be directly positioned over the current collector and may optionally be the only layer of the carbonaceous coating. Examples of suitable activated carbon particles may include, for instance, coconut shell-based activated carbon, petroleum coke-based activated carbon, pitch-based activated carbon, polyvinylidene chloride-based activated carbon, phenolic resin-based activated carbon, polyacrylonitrile-based activated carbon, and activated carbon from natural sources such as coal, charcoal or other natural organic sources.

In certain embodiments, it may be desired to selectively control certain aspects of the activated carbon particles, such as their particle size distribution, surface area, and pore size distribution to help improve ion mobility for certain types of electrolytes after being subjected to one or more charge-discharge cycles. For example, at least 50% by volume of the particles (D50 size) may have a size in the range of from about 0.01 micrometers or more, such as about 0.1 micrometers or more, such as about 0.5 micrometers or more, such as about 1 micrometer or more to about 30 micrometers or less, such as about 25 micrometers or less, such as about 20 micrometers or less, such as about 15 micrometers or less, such as about 10 micrometers or less. At least 90% by volume of the particles (D90 size) may likewise have a size in the range of from about 2 micrometers or more, such as about 5 micrometers or more, such as about 6 micrometers or more to about 40 micrometers or less, such as about 30 micrometers or less, such as about 20 micrometers or less, such as about 15 micrometers or less. The BET surface may also range from about 900 m²/g or more, such as about 1,000 m²/g or more, such as about 1,100 m²/g or more, such as about 1,200 m²/g or more to about 3,000 m²/g or less, such as about 2,500 m²/g or less, such as about 2,000 m²/g or less, such as about 1,800 m²/g or less, such as about 1,500 m²/g or less.

In addition to having a certain size and surface area, the activated carbon particles may also contain pores having a certain size distribution. For example, the amount of pores less than about 2 nanometers in size (i.e., “micropores”) may provide a pore volume of about 50 vol. % or less, such as about 40 vol. % or less, such as about 30 vol. % or less, such as about 20 vol. % or less, such as about 15 vol. % or less, such as about 10 vol. % or less, such as about 5 vol. % or less of the total pore volume. The amount of pores less than about 2 nanometers in size (i.e., “micropores”) may provide a pore volume of about 0 vol % or more, such as about 0.1 vol % or more, such as about 0.5 vol % or more, such as 1 vol % or more of the total pore volume. The amount of pores between about 2 nanometers and about 50 nanometers in size (i.e., “mesopores”) may likewise be about 20 vol. % or more, such as about 25 vol. % or more, such as about 30 vol. % or more, such as about 35 vol. % or more, such as about 40 vol. % or more, such as about 50 vol. % or more of the total pore volume. The amount of pores between about 2 nanometers and about 50 nanometers in size (i.e., “mesopores”) may be about 90 vol. % or less, such as about 80 vol. % or less, such as about 75 vol. % or less, such as about 65 vol. % or less, such as about 55 vol. % or less, such as about 50 vol. % or less of the total pore volume. Finally, the amount of pores greater than about 50 nanometers in size (i.e., “macropores”) may be about 1 vol. % or more, such as about 5 vol. % or more, such as about 10 vol. % or more, such as about 15 vol. % or more of the total pore volume. The amount of pores greater than about 50 nanometers in size (i.e., “macropores”) may be about 50 vol. % or less, such as about 40 vol. % or less, such as about 35 vol. % or less, such as about 30 vol. % or less, such as about 25 vol. % or less of the total pore volume. The total pore volume of the carbon particles may be in the range of from about 0.2 cm³/g or more, such as about 0.4 cm³/g or more, such as about, 0.5 cm³/g or more to about 1.5 cm³/g or less, such as about 1.3 cm³/g or less, such as about 1.0 cm³/g or less, such as about 0.8 cm³/g or less. The median pore width may be about 8 nanometers or less, such as about 5 nanometers or less, such as about 4 nanometers or less. The median pore width may be about 1 nanometer or more, such as about 2 nanometers or more. The pore sizes and total pore volume may be measured using nitrogen adsorption and analyzed by the Barrett-Joyner-Halenda (“BJH”) technique as is well known in the art.

One unique aspect of the present invention is that the electrodes need not contain a substantial amount of binders conventionally employed in ultracapacitor electrodes. That is, binders may be present in an amount of about 60 parts or less, such as about 40 parts or less, such as about 30 parts or less, such as about 25 parts or less, such as about 20 parts or less to about 1 part or more, such as about 5 parts or more per 100 parts of carbon in the carbonaceous coating. Binders may, for example, constitute about 15 wt. % or less, such as about 10 wt. % or less, such as about 8 wt. % or less, such as about 5 wt. % or less, such as about 4 wt. % or less of the total weight of the carbonaceous coating. The binders may constitute about 0.1 wt. % or more, such as about 0.5 wt. % or more, such as about 1 wt. % or more of the total weight of the carbonaceous coating.

Nevertheless, when employed, any of a variety of suitable binders can be used in the electrodes. For instance, water-insoluble organic binders may be employed in certain embodiments, such as styrene-butadiene copolymers, polyvinyl acetate homopolymers, vinyl-acetate ethylene copolymers, vinyl-acetate acrylic copolymers, ethylene-vinyl chloride copolymers, ethylene-vinyl chloride-vinyl acetate terpolymers, acrylic polyvinyl chloride polymers, acrylic polymers, nitrile polymers, fluoropolymers such as polytetrafluoroethylene or polyvinylidene fluoride, polyolefins, etc., as well as mixtures thereof. Water-soluble organic binders may also be employed, such as polysaccharides and derivatives thereof. In one particular embodiment, the polysaccharide may be a nonionic cellulosic ether, such as alkyl cellulose ethers (e.g., methyl cellulose and ethyl cellulose); hydroxyalkyl cellulose ethers (e.g., hydroxyethyl cellulose, hydroxypropyl cellulose, hydroxypropyl hydroxybutyl cellulose, hydroxyethyl hydroxypropyl cellulose, hydroxyethyl hydroxybutyl cellulose, hydroxyethyl hydroxypropyl hydroxybutyl cellulose, etc.); alkyl hydroxyalkyl cellulose ethers (e.g., methyl hydroxyethyl cellulose, methyl hydroxypropyl cellulose, ethyl hydroxyethyl cellulose, ethyl hydroxypropyl cellulose, methyl ethyl hydroxyethyl cellulose and methyl ethyl hydroxypropyl cellulose); carboxyalkyl cellulose ethers (e.g., carboxymethyl cellulose); and so forth, as well as protonated salts of any of the foregoing, such as sodium carboxymethyl cellulose.

If desired, other materials may also be employed within an activated carbon layer of the carbonaceous materials. For example, in certain embodiments, a conductivity promoter may be employed to further increase electrical conductivity. Exemplary conductivity promoters may include, for instance, carbon black, graphite (natural or artificial), graphite, carbon nanotubes, nanowires or nanotubes, metal fibers, graphenes, etc., as well as mixtures thereof. Carbon black is particularly suitable in one embodiment. In another embodiment, carbon nanotubes are particularly suitable. When employed, conductivity promoters typically constitute about 60 parts or less, such as about 40 parts or less, such as about 30 parts or less, such as about 25 parts or less, such as about 20 parts or less to about 1 part or more, such as about 5 parts or more per 100 parts of carbon in the carbonaceous coating. Conductivity promoters may, for example, constitute about 15 wt. % or less, such as about 10 wt. % or less, such as about 8 wt. % or less, such as about 5 wt. % or less, such as about 4 wt. % or less of the total weight of the carbonaceous coating. The conductivity promoters may constitute about 0.1 wt. % or more, such as about 0.5 wt. % or more, such as about 1 wt. % or more of the total weight of the carbonaceous coating. Meanwhile, activated carbon particles likewise typically constitute 85 wt. % or more, such as about 90 wt. % or more, such as about 95 wt. % or more, such as about 97 wt. % or more of the total weight of the carbonaceous coating. The activated carbon particles may constitute less than 100 wt. %, such as about 99.5 wt. % or less, such as about 99 wt. % or less, such as about 98 wt. % or less of the total weight of the carbonaceous coating.

The particular manner in which a carbonaceous material is coated onto to the sides of a current collector may vary as is well known to those skilled in the art, such as printing (e.g., rotogravure), spraying, slot-die coating, drop-coating, dip-coating, etc. Regardless of the manner in which it is applied, the resulting electrode is typically dried to remove moisture from the coating, such as at a temperature of about 100° C. or more, in some embodiments about 200° C. or more, and in some embodiments, from about 300° C. to about 500° C. The electrode may also be compressed (e.g., calendared) to optimize the volumetric efficiency of the ultracapacitor. After any optional compression, the thickness of each carbonaceous coating may generally vary based on the desired electrical performance and operating range of the ultracapacitor. Typically, however, the thickness of a coating is from about 20 to about 200 micrometers, 30 to about 150 micrometers, and in some embodiments, from about 40 to about 100 micrometers. Coatings may be present on one or both sides of a current collector. Regardless, the thickness of the overall electrode (including the current collector and the carbonaceous coating(s) after optional compression) is typically within a range of from about 20 to about 350 micrometers, in some embodiments from about 30 to about 300 micrometers, and in some embodiments, from about 50 to about 250 micrometers.

Separator

As indicated above, the electrode assembly may include a separator positioned between the first electrode and the second electrode. The separator can enable electrical isolation of one electrode from another to help prevent an electrical short but still allow transport of ions between the two electrodes. In certain embodiments, for example, a separator may be employed that includes a cellulosic fibrous material (e.g., airlaid paper web, wet-laid paper web, etc.), nonwoven fibrous material (e.g., polyolefin nonwoven webs), woven fabrics, film (e.g., polyolefin film), etc. Cellulosic fibrous materials are particularly suitable for use in the ultracapacitor, such as those containing natural fibers, synthetic fibers, etc. Specific examples of suitable cellulosic fibers for use in the separator may include, for instance, hardwood pulp fibers, softwood pulp fibers, rayon fibers, regenerated cellulosic fibers, etc.

Regardless of the particular materials employed, the separator typically has a thickness of about 150 micrometers or less, such as about 100 micrometers or less, such as about 80 micrometers or less, such as about 50 micrometers or less, such as about 40 micrometers or less, such as about 30 micrometers or less. The separator may have a thickness of about 1 micrometer or more, such as about 5 micrometers or more, such as about 10 micrometers or more, such as about 20 micrometers or more.

Nonaqueous Electrolyte

In addition, the ultracapacitor may also include an electrolyte employed within the housing. The electrolyte is generally nonaqueous in nature and thus contains at least one nonaqueous solvent. To help extend the operating temperature range of the ultracapacitor, it is typically desired that the nonaqueous solvent have a relatively high boiling temperature, such as about 150° C. or more, in some embodiments about 200° C. or more, and in some embodiments, from about 220° C. to about 300° C. Particularly suitable high boiling point solvents may include, for instance, cyclic carbonate solvents, such as ethylene carbonate, propylene carbonate, butylene carbonate, vinylene carbonate, etc. Propylene carbonate is particularly suitable due to its high electric conductivity and decomposition voltage, as well as its ability to be used over a wide range of temperatures. Of course, other nonaqueous solvents may also be employed, either alone or in combination with a cyclic carbonate solvent. Examples of such solvents may include, for instance, open-chain carbonates (e.g., dimethyl carbonate, ethyl methyl carbonate, diethyl carbonate, etc.), aliphatic monocarboxylates (e.g., methyl acetate, methyl propionate, etc.), lactone solvents (e.g., butyrolactone valerolactone, etc.), nitriles (e.g., acetonitrile, glutaronitrile, adiponitrile, methoxyacetonitrile, 3-methoxypropionitrile, etc.), amides (e.g., N,N-dimethylformamide, N,N-diethylacetamide, N-methylpyrrolidinone), alkanes (e.g., nitromethane, nitroethane, etc.), sulfur compounds (e.g., sulfolane, dimethyl sulfoxide, etc.); and so forth.

The electrolyte also contains at least one ionic liquid, which may be dissolved in the nonaqueous solvent. While the concentration of the ionic liquid can vary, it is typically desired that the ionic liquid is present at a relatively high concentration. For example, the ionic liquid may be present in an amount of about 0.8 moles per liter (M) of the electrolyte or more, in some embodiments about 1.0 M or more, such as about 1.2 M or more, such as about 1.3 M or more, such as about 1.5 M or more. The ionic liquid may be present in an amount of about 2.0 M or less, such as about 1.8 M or less, such as about 1.5 M or less, such as about 1.4 M or less, such as about 1.3 M or less.

The ionic liquid is generally a salt having a relatively low melting temperature, such as about 400° C. or less, in some embodiments about 350° C. or less, in some embodiments from about 1° C. to about 100° C., and in some embodiments, from about 5° C. to about 50° C. The salt contains a cationic species and counterion. The cationic species contains a compound having at least one heteroatom (e.g., nitrogen or phosphorous) as a “cationic center.” Examples of such heteroatomic compounds include, for instance, unsubstituted or substituted organoquaternary ammonium compounds, such as ammonium (e.g., trimethylammonium, tetraethylammonium, etc.), pyridinium, pyridazinium, pyramidinium, pyrazinium, imidazolium, pyrazolium, oxazolium, triazolium, thiazolium, quinolinium, piperidinium, pyrrolidinium, quaternary ammonium spiro compounds in which two or more rings are connected together by a spiro atom (e.g., carbon, heteroatom, etc.), quaternary ammonium fused ring structures (e.g., quinolinium, isoquinolinium, etc.), and so forth. In one particular embodiment, for example, the cationic species may be an N-spirobicyclic compound, such as symmetrical or asymmetrical N-spirobicyclic compounds having cyclic rings. One example of such a compound has the following structure:

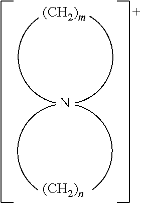

wherein m and n are independently a number from 3 to 7, and in some embodiments, from 4 to 5 (e.g., pyrrolidinium or piperidinium).

Suitable counterions for the cationic species may likewise include halogens (e.g., chloride, bromide, iodide, etc.); sulfates or sulfonates (e.g., methyl sulfate, ethyl sulfate, butyl sulfate, hexyl sulfate, octyl sulfate, hydrogen sulfate, methane sulfonate, dodecylbenzene sulfonate, dodecylsulfate, trifluoromethane sulfonate, heptadecafluorooctanesulfonate, sodium dodecylethoxysulfate, etc.); sulfosuccinates; amides (e.g., dicyanamide); imides (e.g., bis(pentafluoroethyl-sulfonyl)imide, bis(trifluoromethylsulfonyl)imide, bis(trifluoromethyl)imide, etc.); borates (e.g., tetrafluoroborate, tetracyanoborate, bis[oxalato]borate, bis[salicylato]borate, etc.); phosphates or phosphinates (e.g., hexafluorophosphate, diethylphosphate, bis(pentafluoroethyl)phosphinate, tris(pentafluoroethyl)-trifluorophosphate, tris(nonafluorobutyl)trifluorophosphate, etc.); antimonates (e.g., hexafluoroantimonate); aluminates (e.g., tetrachloroaluminate); fatty acid carboxylates (e.g., oleate, isostearate, pentadecafluorooctanoate, etc.); cyanates; acetates; and so forth, as well as combinations of any of the foregoing.

Several examples of suitable ionic liquids may include, for instance, spiro-(1,1′)-bipyrrolidinium tetrafluoroborate, triethylmethyl ammonium tetrafluoroborate, tetraethyl ammonium tetrafluoroborate, spiro-(1,1′)-bipyrrolidinium iodide, triethylmethyl ammonium iodide, tetraethyl ammonium iodide, methyltriethylammonium tetrafluoroborate, tetrabutylammonium tetrafluoroborate, tetraethylammonium hexafluorophosphate, etc.

Housing

The ultracapacitor of the present invention employs a housing within which the electrode assembly and electrolyte are retained. The manner in which the components are inserted into the housing may vary as is known in the art. For example, the electrodes and separator may be initially folded, wound, or otherwise contacted together to form an electrode assembly. The electrolyte may optionally be immersed into the electrodes of the assembly. In one particular embodiment, the electrodes, separator, and optional electrolyte may be wound into an electrode assembly having a “jelly-roll” configuration. Referring to FIG. 7, for instance, one embodiment of such a jellyroll electrode assembly 1100 is shown that contains a first electrode 1102, a second electrode 1104, and a separator 1106 positioned between the electrodes 1102 and 1104. In this particular embodiment, the electrode assembly 1100 also includes another separator 1108 that is positioned over the second electrode 1104. In this manner, each of two coated surfaces of the electrodes is separated by a separator, thereby maximizing surface area per unit volume and capacitance. While by no means required, the electrodes 1102 and 1104 are offset in this embodiment so as to leave their respective contact edges extending beyond first and second edges of the first and second separators 1106 and 1108, respectively. Among other things, this can help prevent “shorting” due to the flow of electrical current between the electrodes. However, it should be understood that other configurations may also be utilized. For instance, in another embodiment, the electrodes, separator, and optional electrolyte may be provided as an electrode assembly having a laminar configuration.

As indicated herein, the components may be provided within the housing of the ultracapacitor and optionally hermetically sealed. The nature of the housing may vary as desired. In certain embodiments, for example, the housing may be in the form of a flexible package that encloses the components of the ultracapacitor. Referring to FIG. 4, for example, one embodiment of an ultracapacitor 101 is shown that contains a flexible package 103 that encloses an electrode assembly 102 and electrolyte 112. The electrode assembly 102 may contain electrodes 105 and 106 and a separator (not shown) stacked in a face to face configuration and connected together by opposing tabs 104. The ultracapacitor 101 also contains a first terminal 105 and a second terminal 106, which are respectively electrically connected with the tabs 104. More particularly, the electrodes 105 and 106 have first ends 107 and 108 disposed within the package 103 and respective second ends 109 and 110 disposed outside of the package 103. It should be understood that apart from stacking, the electrode assembly may be provided in any other form desired. For example, the electrodes may be folded or wounded together in a jelly roll configuration.

The package 103 generally includes a substrate 114 that extends between two ends 115 and 116 and that has edges 117, 118, 119 and 120. The ends 115 and 116, as well as the portions of both sides 119 and 120 that overlap, are fixedly and sealingly abutted against one another (e.g., by heat welding). In this manner, the electrolyte 112 can be retained within the package 103. The substrate 114 typically has a thickness of from about 20 micrometers or more, such as about 50 micrometers or more, such as about 100 micrometers or more, such as about 200 micrometers or more, such as about to about 1,000 micrometers or less, such as about 800 micrometers or less, such as about 600 micrometers or less, such as about 400 micrometers or less, such as about 200 micrometers or less.

The substrate 114 may contain any number of layers desired to achieve the desired level of barrier properties, such as 1 or more, in some embodiments 2 or more, and in some embodiments, from 2 to 4 layers. Typically, the substrate contains a barrier layer, which may include a metal, such as aluminum, nickel, tantalum, titanium, stainless steel, etc. Such a barrier layer is generally impervious to the electrolyte so that it can inhibit leakage thereof, and also generally impervious to water and other contaminants. If desired, the substrate may also contain an outer layer that serves as a protective layer for the package. In this manner, the barrier layer is positioned between the outer layer and the electrode assembly. The outer layer may, for instance, be formed from a polymer film, such as those formed from a polyolefin (e.g., ethylene copolymers, propylene copolymers, propylene homopolymers, etc.), polyesters, etc. Particularly suitable polyester films may include, for example, polyethylene terephthalate, polyethylene naphthalate, polybutylene terephthalate, etc.

If desired, the substrate may also contain an inner layer that is positioned between the electrode assembly and the barrier layer. In certain embodiments, the inner layer may contain a heat-sealable polymer. Suitable heat-sealable polymers may include, for instance, vinyl chloride polymers, vinyl chloridine polymers, ionomers, etc., as well as combinations thereof. Ionomers are particularly suitable. In one embodiment, for instance, the ionomer may be a copolymer that contains an α-olefin and (meth)acrylic acid repeating unit. Specific α-olefins may include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Ethylene is particularly suitable. As noted, the copolymer may also a (meth)acrylic acid repeating unit. As used herein, the term “(meth)acrylic” includes acrylic and methacrylic monomers, as well as salts or esters thereof, such as acrylate and methacrylate monomers. Examples of such (meth)acrylic monomers may include methyl acrylate, ethyl acrylate, n-propyl acrylate, i-propyl acrylate, n-butyl acrylate, s-butyl acrylate, i-butyl acrylate, t-butyl acrylate, n-amyl acrylate, amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, 2-hydroxyethyl methacrylate, n-propyl methacrylate, n-butyl methacrylate, i-propyl methacrylate, i-butyl methacrylate, n-amyl methacrylate, n-hexyl methacrylate, amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, isobornyl methacrylate, etc., as well as combinations thereof. Typically, the α-olefin/(meth)acrylic acid copolymer is at least partially neutralized with a metal ion to form the ionomer. Suitable metal ions may include, for instance, alkali metals (e.g., lithium, sodium, potassium, etc.), alkaline earth metals (e.g., calcium, magnesium, etc.), transition metals (e.g., manganese, zinc, etc.), and so forth, as well as combinations thereof. The metal ions may be provided by an ionic compound, such as a metal formate, acetate, nitrate, carbonate, hydrogen carbonate, oxide, hydroxide, alkoxide, and so forth.

Apart from a flexible package, such as described above, other housing configurations may also be employed. For example, the housing may contain a metal container (“can”), such as those formed from tantalum, niobium, aluminum, nickel, hafnium, titanium, copper, silver, steel (e.g., stainless), alloys thereof, composites thereof (e.g., metal coated with electrically conductive oxide), and so forth. Aluminum is particularly suitable for use in the present invention. The metal container may have any of a variety of different shapes, such as cylindrical, D-shaped, etc. Cylindrically-shaped containers are particular suitable.

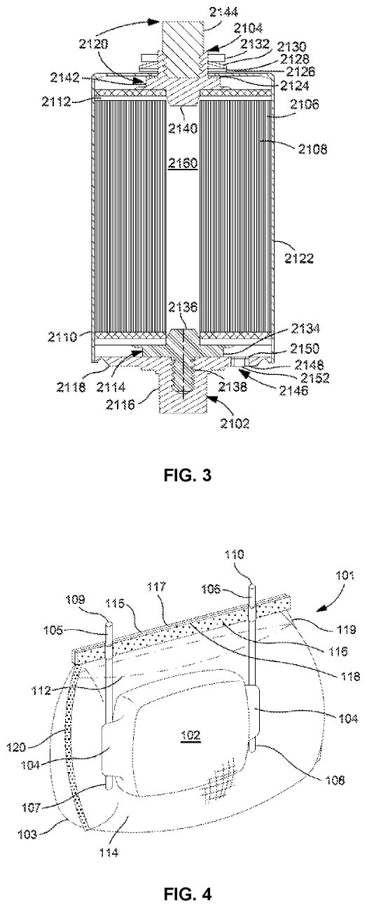

The electrode assembly may be sealed within the cylindrical housing using a variety of different techniques. Referring to FIG. 3, one embodiment of an ultracapacitor is shown that contains an electrode assembly 2108, which contains layers 2106 wound together in a jellyroll configuration as discussed above. In this particular embodiment, the ultracapacitor contains a first collector disc 2114, which contains a disc-shaped portion 2134, a stud portion 2136, and a fastener 2138 (e.g., screw). The collector disc 2114 is aligned with a first end of a hollow core 2160, which is formed in the center of the electrode assembly, and the stud portion 2136 is then inserted into an opening of the core so that the disc-shaped portion 2134 sits against the first end of the electrode assembly 2108 at a first contact edge 2110. A lid 2118 is welded (e.g., laser welded) to a first terminal post 2116, and a socket, which may be for example, threaded, is coupled to the fastener 2138. The ultracapacitor also contains a second collector disc 2120, which contains a disc-shaped portion 2142, a stud portion 2140, and a second terminal post 2144. The second collector disc 2120 is aligned with the second end of the hollow core 2160, and the stud portion 2140 is then inserted into the opening of the core so that the collector disc portion 2142 sits against the second end of the electrode assembly 2108.

A metal container 2122 (e.g., cylindrically-shaped can) is thereafter slid over the electrode assembly 2108 so that the second collector disc 2120 enters the container 2122 first, passes through a first insulating washer 2124, passes through an axial hole at an end of the container 2122, and then passes through a second insulating washer 2126. The second collector disc 2120 also passes through a flat washer 2128 and a spring washer 2130. A locknut 2132 is tightened over the spring washer 2130, which compresses the spring washer 2130 against the flat washer 2128, which in turn is compressed against the second insulating washer 2126. The second insulating washer 2126 is compressed against the exterior periphery of the axial hole in the metal container 2122, and as the second collector disc 2120 is drawn by this compressive force toward the axial hole, the first insulating washer 2124 is compressed between the second collector disc 2120 and an interior periphery of the axial hole in the container 2122. A flange on the first insulating washer 2124 inhibits electrical contact between the second collector disc 2120 and a rim of the axial hole. Simultaneously, the lid 2118 is drawn into an opening of the container 2122 so that a rim of the lid 2118 sits just inside a lip of the opening of the container 2122. The rim of the lid 2118 is then welded to the lip of the opening of the container 2122.

Once the locknut 2132 is tightened against the spring washer 2130, a hermetic seal may be formed between the axial hole, the first insulating washer 2124, the second insulating washer 2126, and the second collector disc 2120. Similarly, the welding of the lid 2118 to the lip of the container 2122, and the welding of the lid 2118 to the first terminal post 2116, may form another hermetic seal. A hole 2146 in the lid 2118 can remain open to serve as a fill port for the electrolyte described above. Once the electrolyte is in the can (i.e., drawn into the can under vacuum, as described above), a bushing 2148 is inserted into the hole 2146 and seated against a flange 2150 at an interior edge of the hole 2146. The bushing 2148 may, for instance, be a hollow cylinder in shape, fashioned to receive a plug 2152. The plug 2152, which is cylindrical in shape, is pressed into a center of the bushing 2148, thereby compressing the bushing 2148 against an interior of the hole 2146 and forming a hermetic seal between the hole 2146, the bushing 2148, and the plug 2152. The plug 2152 and the bushing 2148 may be selected to dislodge when a prescribed level of pressure is reached within the ultracapacitor, thereby forming an overpressure safety mechanism.

The embodiments described above generally refer to the use of a single electrode assembly in the ultracapacitor. It should of course be understood, however, that the capacitor of the present invention may also contain two or more electrode assemblies. For instance, in one such embodiment, for example, the ultracapacitor may include a stack of two or more electrode assemblies, which may be the same or different.

Properties and Applications

The ultracapacitor utilized according to the present invention may exhibit excellent electrical properties, in particular when exposed to high temperatures. For example, the ultracapacitor may exhibit a capacitance of about 6 Farads per cubic centimeter (“F/cm³”) or more, in some embodiments about 8 F/cm³ or more, in some embodiments from about 9 to about 100 F/cm³, and in some embodiments, from about 10 to about 80 F/cm³, measured at a temperature of 23° C., frequency of 120 Hz, and without an applied voltage. The ultracapacitor may also have a low equivalence series resistance (“ESR”), such as about 150 mohms or less, in some embodiments less than about 125 mohms, in some embodiments from about 0.01 to about 100 mohms, and in some embodiments, from about 0.05 to about 70 mohms, determined at a temperature of 23° C., frequency of 1 kHz, and without an applied voltage. As indicated above, the resulting ultracapacitor may exhibit a wide variety of beneficial electrical properties, such as improved capacitance and ESR values. Notably, the ultracapacitor may exhibit excellent electrical properties even when exposed to high temperatures. For example, the ultracapacitor may be placed into contact with an atmosphere having a temperature of from about 80° C. or more, in some embodiments from about 100° C. to about 150° C., and in some embodiments, from about 105° C. to about 130° C. (e.g., 85° C. or 105° C.). The capacitance and ESR values can remain stable at such temperatures for a substantial period of time, such as for about 100 hours or more, in some embodiments from about 300 hours to about 5000 hours, and in some embodiments, from about 600 hours to about 4500 hours (e.g., 168, 336, 504, 672, 840, 1008, 1512, 2040, 3024, or 4032 hours).

In one embodiment, for example, the ratio of the capacitance value of the ultracapacitor after being exposed to the hot atmosphere (e.g., 85° C. or 105° C.) for 1008 hours to the capacitance value of the ultracapacitor when initially exposed to the hot atmosphere is about 0.75 or more, in some embodiments from about 0.8 to 1.0, and in some embodiments, from about 0.85 to 1.0. Such high capacitance values can also be maintained under various extreme conditions, such as when applied with a voltage and/or in a humid atmosphere. For example, the ratio of the capacitance value of the ultracapacitor after being exposed to the hot atmosphere (e.g., 85° C. or 105° C.) and an applied voltage to the initial capacitance value of the ultracapacitor when exposed to the hot atmosphere but prior to being applied with the voltage may be about 0.60 or more, in some embodiments from about 0.65 to 1.0, and in some embodiments, from about 0.7 to 1.0. The voltage may, for instance, be about 1 volt or more, in some embodiments about 1.5 volts or more, and in some embodiments, from about 2 to about 10 volts (e.g., 2.1 volts). In one embodiment, for example, the ratio noted above may be maintained for 1008 hours or more. The ultracapacitor may also maintain the capacitance values noted above when exposed to high humidity levels, such as when placed into contact with an atmosphere having a relative humidity of about 40% or more, in some embodiments about 45% or more, in some embodiments about 50% or more, and in some embodiments, about 70% or more (e.g., about 85% to 100%). Relative humidity may, for instance, be determined in accordance with ASTM E337-02, Method A (2007). For example, the ratio of the capacitance value of the ultracapacitor after being exposed to the hot atmosphere (e.g., 85° C. or 105° C.) and high humidity (e.g., 85%) to the initial capacitance value of the ultracapacitor when exposed to the hot atmosphere but prior to being exposed to the high humidity may be about 0.7 or more, in some embodiments from about 0.75 to 1.0, and in some embodiments, from about 0.80 to 1.0. In one embodiment, for example, this ratio may be maintained for 1008 hours or more.

The ESR can also remain stable at such temperatures for a substantial period of time, such as noted above. In one embodiment, for example, the ratio of the ESR of the ultracapacitor after being exposed to the hot atmosphere (e.g., 85° C. or 105° C.) for 1008 hours to the ESR of the ultracapacitor when initially exposed to the hot atmosphere is about 1.5 or less, in some embodiments about 1.2 or less, and in some embodiments, from about 0.2 to about 1. Notably, such low ESR values can also be maintained under various extreme conditions, such as when applied with a high voltage and/or in a humid atmosphere as described above. For example, the ratio of the ESR of the ultracapacitor after being exposed to the hot atmosphere (e.g., 85° C. or 105° C.) and an applied voltage to the initial ESR of the ultracapacitor when exposed to the hot atmosphere but prior to being applied with the voltage may be about 1.8 or less, in some embodiments about 1.7 or less, and in some embodiments, from about 0.2 to about 1.6. In one embodiment, for example, the ratio noted above may be maintained for 1008 hours or more. The ultracapacitor may also maintain the ESR values noted above when exposed to high humidity levels. For example, the ratio of the ESR of the ultracapacitor after being exposed to the hot atmosphere (e.g., 85° C. or 105° C.) and high humidity (e.g., 85%) to the initial capacitance value of the ultracapacitor when exposed to the hot atmosphere but prior to being exposed to the high humidity may be about 1.5 or less, in some embodiments about 1.4 or less, and in some embodiments, from about 0.2 to about 1.2. In one embodiment, for example, this ratio may be maintained for 1008 hours or more.

The exoskeleton as disclosed herein may be utilized for a variety of applications. These applications may include those, but not limited to, for medical applications, military applications, or industrial applications. For instance, the exoskeleton may be used by military professionals for carrying equipment, medical professionals for carrying patients, etc. The exoskeleton may be utilized for enhanced precision during surgery. In industrial applications, the exoskeleton may be utilized to carry heavy equipment and/or materials. It should be understood that the exoskeleton as disclosed herein may be utilized for a variety of other applications.

### Test Methods

Equivalent Series Resistance (ESR):

Equivalence series resistance may be measured using a Keithley 3330 Precision LCZ meter with a DC bias of 0.0 volts, 1.1 volts, or 2.1 volts (0.5 volt peak to peak sinusoidal signal). The operating frequency is 1 kHz. A variety of temperature and relative humidity levels may be tested. For example, the temperature may be 23° C., 85° C. or 105° C., and the relative humidity may be 25% or 85%.

Capacitance:

The capacitance may be measured using a Keithley 3330 Precision LCZ meter with a DC bias of 0.0 volts, 1.1 volts, or 2.1 volts (0.5 volt peak to peak sinusoidal signal). The operating frequency is 120 Hz. A variety of temperature and relative humidity levels may be tested. For example, the temperature may be 23° C., 85° C. or 105° C., and the relative humidity may be 25% or 85%.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A powered exoskeleton comprising:
a power system including at least one ultracapacitor, wherein the at least one ultracapacitor includes a housing and an electrode assembly and electrolyte within the housing; and
a first exoskeleton member and a second exoskeleton member connected to at least one actuator at an exoskeleton joint; wherein the at least one actuator is electrically coupled to and powered by the power system to actuate the exoskeleton joint.

2. The powered exoskeleton of claim 1, wherein the exoskeleton further comprises a control unit electrically connected to the power system and the at least one actuator.

3. The powered exoskeleton of claim 1, wherein the exoskeleton comprises a third exoskeleton member connected to the second exoskeleton member at a second exoskeleton joint.

4. The powered exoskeleton of claim 3, wherein a second exoskeleton joint is associated with a second actuator.

5. The powered exoskeleton of claim 4, wherein each actuator is electrically coupled to and powered by a respective power system.

6. The powered exoskeleton of claim 1, wherein the exoskeleton comprises multiple power systems attached at different locations on the exoskeleton.

7. The powered exoskeleton of claim 1, wherein the exoskeleton further comprises a reserve power system for providing power to the at least one actuator.

8. The powered exoskeleton of claim 1, wherein the power system is rechargeable.

9. The powered exoskeleton of claim 8, wherein the rechargeable power system is rechargeable wirelessly.

10. The powered exoskeleton of claim 1, wherein the exoskeleton further comprises an attachment member to allow the exoskeleton to be operatively attached to a user.

11. The powered exoskeleton of claim 1, wherein the power system further comprises a battery.

12. The powered exoskeleton of claim 1, wherein the electrode assembly is in a jellyroll configuration.

13. The powered exoskeleton of claim 1, wherein the electrode assembly is in a laminar configuration.

14. The powered exoskeleton of claim 1, wherein the electrode assembly contains a first electrode that comprises a first current collector electrically coupled to a first carbonaceous coating, a second electrode that comprises a second current collector electrically coupled to a second carbonaceous coating wherein the first current collector and the second current collector each contain a substrate that includes a conductive metal, and a separator positioned between the first electrode and the second electrode.

15. The powered exoskeleton of claim 14, wherein the conductive metal is aluminum or an alloy thereof.

16. The powered exoskeleton of claim 14, wherein a plurality of fiber-like whiskers project outwardly from the substrate of the first current collector, the substrate of the second current collector, or both.

17. The powered exoskeleton of claim 16, wherein the whiskers contain a carbide of the conductive metal.

18. The powered exoskeleton of claim 14, wherein the carbonaceous coating of the first electrode, the second electrode, or a combination thereof contains activated carbon particles.

19. The powered exoskeleton of claim 18, wherein at least 50% by volume of the activated carbon particles have a size of from about 0.01 to about 30 micrometers.

20. The powered exoskeleton of claim 18, wherein the activated carbon particles contain a plurality of pores, wherein the amount of pores having a size of about 2 nanometers or less is about 50 vol. % or less of the total pore volume, the amount of pores having a size of from about 2 nanometers to about 50 nanometers is about 20 vol. % to about 80 vol. % of the total pore volume, and the amount of pores having a size of about 50 nanometers or more is from about 1 vol. % to about 50 vol. % of the total pore volume.

21-29. (canceled)
